(19) United States
(12) Patent Application Publication
(10) Pub. No.: US 2009/0040747 A1
(43) Pub. Date: Feb. 12, 2009

(54) KEYBOARD WITH LIGHTING CIRCUIT

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HONHAI PRECISION INDUSTRY CO., LTD., Tu-Cheng (TW)

(21) Appl. No.: 11/946,864

(22) Filed: Nov. 29, 2007

(30) Foreign Application Priority Data
Aug. 9, 2007 (CN) 200710201318.6

(51) Int. Cl. H01H 13/70

(52) U.S. Cl. 362/85

(57) ABSTRACT

An exemplary keyboard includes at least one lighting circuit and a keypad mounted on the keyboard. The lighting circuit comprises a power source, at least one light emitting diode (LED), and a regulating resistor. The regulating resistor includes an adjustment terminal connected to the power source and a connection terminal connected to the anode of the LED. The cathode of the LED is grounded. The keypad is illuminated by the lighting circuit arranged therein. Therefore, users can adjust illumination of different parts of the keyboard by adjusting the regulating resistors of the lighting circuits arranged therein.

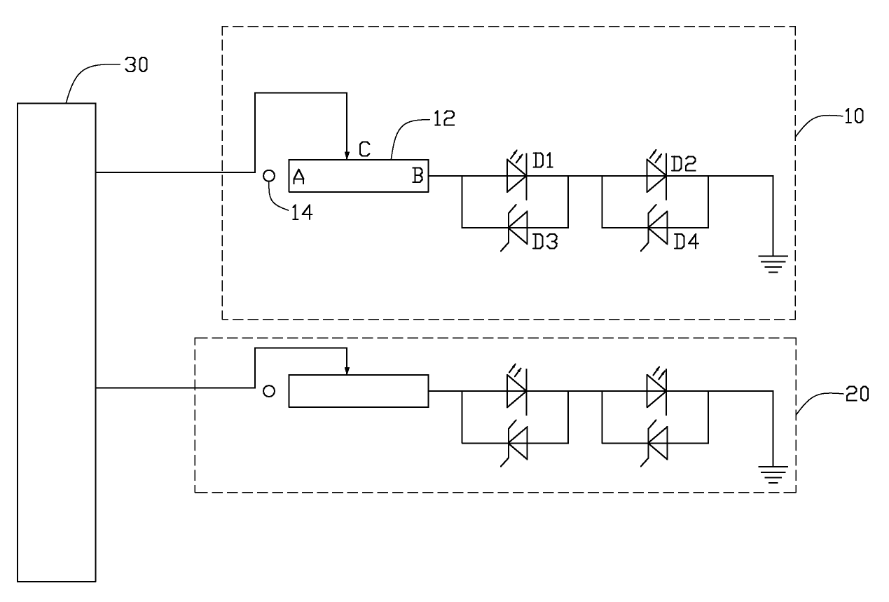

### BACKGROUND

1. Field of the Invention

The present invention relates to a keyboard with lighting circuits.

2. Description of Related Art

A computer system includes many components, such as the central processing unit (or processor), temporary memory for storing program instructions (like random access memory, or RAM), a permanent storage device (such as a hard disk), and a variety of user interface devices, such as a video display, a keyboard, and a pointing device.

The keyboard may come in a variety of physical embodiments. The most familiar is a plastic enclosure made of two halves that are fixed together with at least one cutout in the top half for a keypad. The standard keyboard has an alphanumeric keypad and a number keypad to the right of the alphanumeric keypad. The keypads have keys that correspond to pressure sensitive switches. The pressure sensitive switches are mounted on a printed circuit board (PCB) underneath the keypads and within the enclosure. The PCB also has a keyboard control circuit that, when a key is pressed, determines which key was pressed and transmits an electrical signal to the computer system. The computer system then decodes the electrical signal and performs some defined action such as printing a character on the video display or executing a defined command. Other embodiments of a keyboard include different alphanumeric keypad layouts, reduced size keypads and keyboards, metal enclosures, cutouts for each individual key, integration of a pointing device, etc.

Keyboards are used in a variety of applications for entry of alphanumeric and other types of data into a computer system. But it is hard to use a keyboard in a dark or gloomy environment.

### SUMMARY

An exemplary keyboard includes at least one lighting circuit and a keypad mounted on the keyboard. The lighting circuit comprises a power source, at least one light emitting diode (LED), and a regulating resistor. The regulating resistor includes an adjustment terminal connected to the power source and a connection terminal connected to the anode of the LED. The cathode of the LED is grounded. The keypad is illuminated by the lighting circuit arranged therein.

Other advantages and novel features of the present invention will become more apparent from the following detailed description of preferred embodiment when taken in conjunction with the accompanying drawing, in which:

### BRIEF DESCRIPTION OF THE DRAWINGS

The drawing is a circuit diagram of a keyboard in accordance with the present invention.

### DETAILED DESCRIPTION

Referring to the drawing, a keyboard in accordance with an embodiment of the present invention includes two lighting circuits 10 and 20, and a circuit board of the keyboard. The lighting circuit 10 includes two light emitting diodes (LEDs) D1 and D2, two Zener diodes D3 and D4, and a regulating resistor 12. The regulating resistor 12 includes a vacant end A, an opposite end B connected to the anode of the LED D1, and an adjustment terminal C connected to the circuit board 30 to get power. The cathode of the LED D1 is connected to the anode of the LED D2, and the cathode of the LED D2 is grounded. The Zener diodes D3 and D4 are connected in parallel with the LED D1 and D2 respectively for voltage regulation. Therefore, the illumination of the LEDs D1 and D2 can be adjusted by adjusting a position of the terminal C between the ends A and B.

The lighting circuit 20 is the same as the lighting circuit 10. The lighting 10 is arranged in a main keypad mounted on the keyboard, and the lighting circuit 20 is arranged in a numeric keypad mounted on the keyboard. The lighting circuits 10 and 20 illuminate the main keypad and the numeric keypad respectively.

Therefore, users can adjust the illumination of different parts of the keyboard by adjusting the regulating resistors of the lighting circuits arranged therein.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A keyboard comprising:
at least one lighting circuit that comprises:
a power source;
at least one light emitting diode (LED) with the cathode grounded; and
a regulating resistor having an adjust terminal connected to the power source and a connection terminal connected to the anode of the LED; and
a keypad mounted on the keyboard and illuminated by the lighting circuit, wherein the lighting circuit is arranged in the keypad.

2. The keyboard as claimed in claim 1, wherein the lighting circuit further includes a Zener diode to connect in parallel with the LED for voltage regulation.

3. The keyboard as claimed in claim 1, wherein the keyboard includes two lighting circuits arranged in a main keypad and a numeric keypad of the keyboard respectively.
